(19) United States
(12) Patent Application Publication
(10) Pub. No.: US 2026/0266495 A1
(43) Pub. Date: Sep. 10, 2026

(54) REAL TIME VIRTUAL SENSOR MONITORING SYSTEM FOR MULTI USE FACILITIES AND OPERATING METHOD THEREOF

(71) Applicant: KOREA ELECTRONICS TECHNOLOGY INSTITUTE, Seongnam-si (KR)

(72) Inventors: Myungsung LEE, Seoul (KR); Joo Han KIM, Seoul (KR); Kyunghwan CHA, Siheung-si (KR); Gyeonghyeok KANG, Seoul (KR)

(21) Appl. No.: 19/666,033

(22) Filed: May 1, 2026

Related U.S. Application Data
(63) Continuation of application No. PCT/KR2024/005866, filed on Apr. 30, 2024.

(30) Foreign Application Priority Data
Dec. 29, 2023 (KR) 10-2023-0197655

(51) Int. Cl. F24F 11/63; F24F 11/46

(52) U.S. Cl. CPC F24F 11/63; F24F 11/46

(57) ABSTRACT

Proposed is a real time virtual sensor monitoring system for multi use facilities, and an operating method of the real time virtual sensor monitoring system. The system may include an input processor creating a plurality of air conditioner measurement data and a plurality of indoor environmental measurement data in a multi use facility. The system may also include a calculation processor including a preprocessing processor receiving and preprocessing the plurality of air conditioner measurement data and the plurality of indoor environmental measurement data. The system may further include a simulation processor receiving preprocessed data through the preprocessing processor and performing simulation. The system may further include a parameter creation processor transmitting information dividing the multi use facility into o (o is a natural number) zone to the calculation processor, and an output processor receiving the result of the simulation through the calculation processor and outputting virtual sensor distribution.

### CROSS REFERENCE TO RELATED APPLICATIONS

This is a continuation application of International Patent Application No. PCT/KR2024/005866 filed on Apr. 30, 2024, which claims priority to Korean patent application No. 10-2023-0197655 filed on Dec. 29, 2023, contents of each of which are incorporated herein by reference in their entireties.

### BACKGROUND

### Technical Field

The present disclosure relates to a real time virtual sensor monitoring system for multi use facilities and an operating method thereof.

More particularly, the present disclosure relates to a real time virtual sensor monitoring system for multi use facilities that uses a reduced order model (ROM), and an operating method thereof.

### Description of Related Technology

In order to efficiently manage energy (e.g., electrical energy for operating air conditioners, etc.) that is used in multi use facilities (e.g., buildings such as a department store), big data is created by collecting data received through environmental sensors (e.g., a temperature sensor, an airflow sensor, an air volume sensor, etc.). Thereafter, it is possible to efficiently manage the energy that is used in multi use facilities on the basis of the collected big data. For example, it is possible to construct a model that intensively operates air conditioners at sites where people who use multi use facilities are concentrated in summer.

### SUMMARY

One aspect is a real time virtual sensor monitoring system for multi use facilities that can simplify models, reduce calculation cost, and achieve a quick calculation result by using a reduced order model.

Another aspect is an operating method of the real time virtual sensor monitoring system for multi use facilities that can simplify models, reduce calculation cost, and achieve a quick calculation result by using a reduced order model.

Another aspect is a real time virtual sensor monitoring system for multi use facilities that includes an input processor creating a plurality of air conditioner measurement data and a plurality of indoor environmental measurement data in a multi use facility, a calculation processor including a preprocessing processor receiving and preprocessing the plurality of air conditioner measurement data and the plurality of indoor environmental measurement data, and a simulation processor receiving preprocessed data through the preprocessing processor and performing simulation, a parameter creation processor transmitting information dividing the multi use facility into o (o is a natural number) zone to the calculation processor, and an output processor receiving the result of the simulation through the calculation processor and outputting virtual sensor distribution, in which the preprocessing processor includes, a block collecting real-time data through sensors in the multi use facility, a block transmitting measurement data sensed at every cycle in the real-time data to a building automation system, a block transmitting input data for user-desired simulation AHU setting values in the real-time data to the building automation system, a block performing preprocessing calculation on data of the block transmitting the measurement data sensed at every cycle, a block receiving the data preprocessed by the block performing preprocessing calculation and the user-desired simulation AHU setting values and creating reduced order model input data, and a block transmitting the reduced order model input data to a Twin Builder, and the simulation processor includes a virtual sensor reduced order model block, a user-desired simulation AHS setting value reduced order model block, a block creating a real-time virtual sensor result through the virtual sensor reduced order model block, and a block comparing a What-If virtual sensor variation through a value of the user-desired simulation AHS setting value reduced order model block.

The simulation processor of the real time virtual sensor monitoring system for multi use facilities may further include a block creating PPD RSM by receiving data of the virtual sensor reduced order model block and by receiving a value of the user-desired simulation AHS setting value reduced order model block.

The plurality of air conditioner measurement data of the real time virtual sensor monitoring system for multi use facilities may be air supply or ventilation volume, temperature, and/or humidity.

In the real time virtual sensor monitoring system for multi use facilities, the multi use facility may be composed of n floors (n is a natural number) and the n floors each may include an open site, the plurality of air conditioner measurement data may be data measured through an air conditioner included in the n-th floor of the multi use facility, the plurality of indoor environmental measurement data may be data measured through a p-th sensor (p is a natural number) included in the n-th floor of the multi use facility, and the input processor may create all of indoor environmental measurement data included in the open site of an n−1-th floor of the multi use facility and indoor environmental measurement data included in the open site of an n+1-th floor.

In the real time virtual sensor monitoring system for multi use facilities, when the sensor creating indoor environmental measurement data of the n-th floor is poor, a sensor creating a p−1-th or p+1-th indoor environmental measurement data may be used.

Another aspect is an operating method of a real time virtual sensor monitoring system for multi use facilities that includes transmitting sensor measurement data to a BAS at every cycle through a processing device disposed in a multi use facility, transmitting user-desired simulation AHU data to the BAS through the processing device disposed in the multi use facility, collecting real-time data, and storing and updating a real-time data DB by means of the BAS, receiving the stored and updated data through communication Python Code, discriminating real-time sensor measurement data in the received data and the user-desired simulation AHU data, calculating preprocessing calculation on the real-time sensor measurement data, and transmitting the data on which preprocessing calculation has been performed and the user-desired simulation AHU data as input data of a Twin Builder by means of the Python Code, and performing a reduced order model through a digital twin system using a reduced order model by means of the Twin Builder.

In the operating method of a real time virtual sensor monitoring system for multi use facilities, the Twin Builder may be an ANSYS Twin Builder.

In the operating method of a real time virtual sensor monitoring system for multi use facilities, the Twin Builder may construct the reduced order model composed of Computational Fluid Dynamics (CFD) result data.

In the operating method of a real time virtual sensor monitoring system for multi use facilities, data from the communication Python Code to the Twin Builder may be converted into binary data and transmitted through TCP/IP communication.

The operating method of a real time virtual sensor monitoring system for multi use facilities may further include performing a reduced order model through the digital twin system using a reduced order model and creating a virtual sensor What-If value created through the user-desired simulation AHU data by means of the Twin Builder.

According to the present disclosure, there are provided a real time virtual sensor monitoring system for multi use facilities that can perform real-time monitoring by providing high-precision flow distribution (temperature, airflow, residence time, etc.) improving efficiency of air-conditioning control through a reduced order model-based digital twin, and an operating method thereof.

Further, according to the present disclosure, there are provided a real time virtual sensor monitoring system for multi use facilities that quickly provides indoor flow distribution (temperature, airflow, residence time, etc.) through simulation for user-desired air conditioner setting and increases efficiency in operation of air-conditioning control by comparing a user-set operation result with existing air-conditioning operation on the basis of a comfort index, and an operating method of the real time virtual sensor monitoring system.

### BRIEF DESCRIPTION OF THE DRAWINGS

FIGS. 1A and 1B are exemplary flowcharts illustrating an operating method of a real time virtual sensor monitoring system for multi use facilities according to some embodiments.

FIGS. 2A and 2B are exemplary block diagrams illustrating a real time virtual sensor monitoring system for multi use facilities according to some embodiments.

FIGS. 3A to 3C are exemplary parameter tables illustrating preprocessing calculation in the operating method of a real time virtual sensor monitoring system for multi use facilities according to some embodiments.

FIG. 4 is an exemplary block diagram illustrating a preprocessing device of the real time virtual sensor monitoring system for multi use facilities according to some embodiments.

FIG. 5 is an exemplary flowchart illustrating a preprocessing operation in the operating method of a real time virtual sensor monitoring system for multi use facilities according to some embodiments.

FIG. 6 is an exemplary flowchart illustrating the algorithm of the preprocessing operation in the operating method of a real time virtual sensor monitoring system for multi use facilities according to some embodiments.

FIG. 7 is an exemplary diagram when the total heat generation amount for the entire area of a monitoring site is collectively applied to the operation of the real time virtual sensor monitoring system for multi use facilities.

FIG. 8 is an exemplary diagram showing temperature distribution according to FIG. 7.

FIG. 9 is an exemplary diagram when the heat generation amounts of divided sections of the section of the entire area of a monitoring site are collectively applied to the operation of the real time virtual sensor monitoring system for multi use facilities according to some embodiments.

FIG. 10 is an exemplary diagram showing temperature distribution according to FIG. 8.

FIG. 11 is an exemplary table illustrating the accuracy of the operation of the real time virtual sensor monitoring system for multi use facilities according to some embodiments.

### DETAILED DESCRIPTION

Generally, models that use 3D physical simulation require a long analysis period and high-performance processing devices (e.g., a computer), so there is a defect of limitations in real-time maintenance and application of digital twin models.

In order to overcome this problem, method of efficiently using energy for multi use facilities using a reduced order model is emerging.

Hereinafter, embodiments of the present disclosure are described in detail with reference to the accompanying drawings. The advantages and features of the present disclosure, and methods of achieving them will be clear by referring to the exemplary embodiments that will be described hereafter in detail with reference to the accompanying drawings. However, the spirit of the present disclosure is not limited to the embodiments to be described hereafter and may be implemented in various ways, and the embodiments are provided to complete the description of the present disclosure and let those skilled in the art completely know the scope of the present disclosure, and the spirit of the present disclosure is defined by the claims.

It should be noted that when components are given reference numerals in the drawings, the same components are given the same reference numerals even if they are shown in different drawings. Further, in describing the present disclosure, well-known functions or constructions will not be described in detail when it is determined that the description may unnecessarily obscure the gist of the present disclosure.

Unless defined otherwise, all terms (including technological and scientific terminologies) used herein may be used as meanings that those skilled in the art can commonly understand. Further, terms defined in common dictionaries are not construed ideally or excessively unless specifically clearly defined. The terms used herein are provided to describe embodiments without limiting the present disclosure. In the specification, a singular form includes a plural form unless specifically stated in the sentences.

Spatial relative terms “below”, “beneath”, “lower”, “above”, “upper”, etc. may be used to easily describe the correlation of one component and another component, as shown in the drawings. The spatially relative terms should be construed as terminologies including different directions of components in using or in operating in addition to the directions shown in drawings. For example, when components shown in the drawings are turned upside down, a component described as being “below” or “beneath” another component may be positioned “above” the another component. Accordingly, “below” and “beneath” that are exemplary terms may include both of up and down directions. A component may be oriented in different directions, so the spatially relative terms may be construed in accordance with orientation.

Further, terms “first”, “second”, “A”, “B”, “(a)”, and “(b)” can be used in the following description of the components of the present disclosure. These terms are provided only for discriminating components from other components and, the essence, sequence, or order of the components are not limited by the terms. When a component is described as being “connected”, “combined”, or “coupled” with another component, it should be understood that the component may be directly connected or coupled to another component, but another component may be “connected”, “combined”, or “coupled” between components.

The terms “comprises” and/or “comprising” used herein do not exclude that another component, step, operation, and/or element exist or are added in the stated component, step, operation, and/or element.

Some terms that are used herein will be clearly described before description of the present disclosure.

Hereafter, some embodiments of the present disclosure are described in detail with reference to the accompanying drawings.

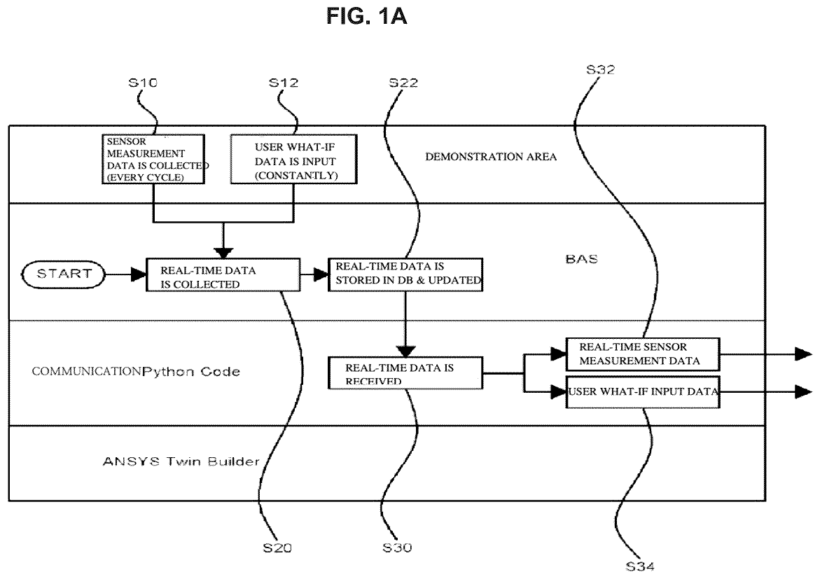

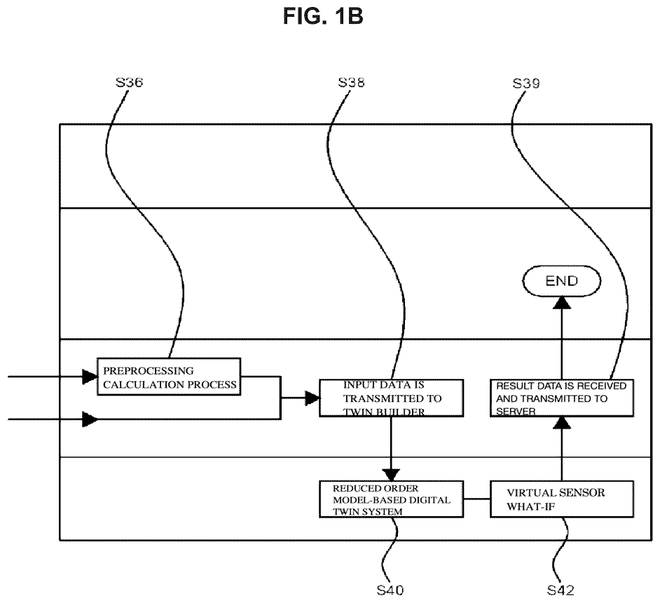

FIGS. 1A and 1B are exemplary flowcharts illustrating an operating method of a real time virtual sensor monitoring system for multi use facilities according to some embodiments.

Referring to FIGS. 1A and 1B, the operation of a real time virtual sensor monitoring system for multi use facilities according to some embodiments may be configured by a digital twin based on a reduced order model.

A processing device (e.g., a computer) disposed in a multi used facility (demonstration area) collects and transmits sensor measurement data to a building automation system (BAS) installed in the multi used facility (demonstration area) at every cycle (e.g., 15 minutes) (S10). A sensor, for example, may be a temperature sensor, a humidity sensor, an air volume sensor for air supply and ventilation of an air conditioner.

Further, the processing device (e.g., a computer) installed in the multi use facility (demonstration area) can constantly receive input data for simulation Air Handing Processor (AHU) setting values (e.g., supply air temperature, air volume, etc.), which a use wants, as user What-If data and can transmit the input data to the building automation system (S12).

The building automation system (BAS) installed in the multi use facility (demonstration area) collects, in real time, data sensed by sensors, What-IF data, etc. (S20). Thereafter, the building automation system stores and updates a real-time data DB (S22).

The data received by the building automation system (BAS) installed in the multi use facility (demonstration area) undergoes a preprocessing process, which converts sensor data into boundary conditions within the range that does not influencing flow to improve calculation time and analytical convergence, and then can be used as real-time simulation boundary condition data.

For the data received by the building automation system (BAS) installed in the multi use facility (demonstration area), data is received in real time using communication Python Code (S30).

Thereafter, real-time sensor measurement data according to step S10 is received (S32). Further, the user What-IF data according to step S12 is received as input data (S34).

The data measured in step S32 undergoes a preprocessing calculation process (S36).

Thereafter, the data according to steps S34 and S36 is transmitted to an input data Twin Builder. For example, in this case, the simulation boundary condition data is converted into binary data and is transmitted to ANSYS Twin Builder, which is a commercial program, through TCP/IP communication.

Thereafter, a digital twin system based on a reduced order model is driven (S40). For example, the digital twin system may be constructed using a reduced order model composed of Computational Fluid Dynamics (CFD) result data. For example, accordingly, it is possible to calculate the temperature, velocity, residence time, etc. at 451 points located at a height of 1.5 meters in an operational demonstration site on the basis of real-time measurement data.

Further, when data according to step S12 is input, a virtual sensor What-IF is driven (S42). For example, the temperature, velocity, residence time, etc. at 451 points located at a height of 1.5 meters in a demonstration site can be calculated through simulation when user-desired air-conditioning setting data in the same environmental condition can be calculated.

The communication Python Code receives the data calculated through ANSYS Twin Builder as result data and transmits it to a server (S39).

Before real-time simulation is performed, in order to use measurement data as simulation boundary conditions, for example, the number of air-conditioning exhaust outlets and resistance at the outlets (uniform exhaust), and the interrelated effect, heat generation due to the flow of people, etc. at open sites such as central halls should be considered. To this end, the environmental measurement data collected from the BAS can be used as simulation boundary conditions for calculation. AHU air supply/ventilation exhaust outlet boundary conditions can be used on the basis of measurement data of an operational AHU.

Further, it is possible to divide the interior of a demonstration site, for example, into 11 zones, calculate the heat generation amount in each zone on the basis of the representative temperature value of an environmental sensor and the data of an air conditioner installed in each zone, and then use the heat generation amounts as boundary conditions.

To consider the interrelated effect of a central hall that is an open site, it is possible to collect and use the temperature values of the open site at the upper and lower layers of a demonstration site as boundary conditions.

When environmental sensor data that is used to calculate indoor boundary conditions is missing, it is possible to apply a sensor close to the missing sensor as substitute sensor data to use the boundary conditions. In this process, by showing an error message, a user can find out problems and it can help ensure the simulation normally proceeds.

As described above, since the operation of the real time virtual sensor monitoring system for multi use facilities according to some embodiments is configured by a digital twin based on a reduced order model, the accuracy of flow analysis of sensor values for multi use facilities can be improved.

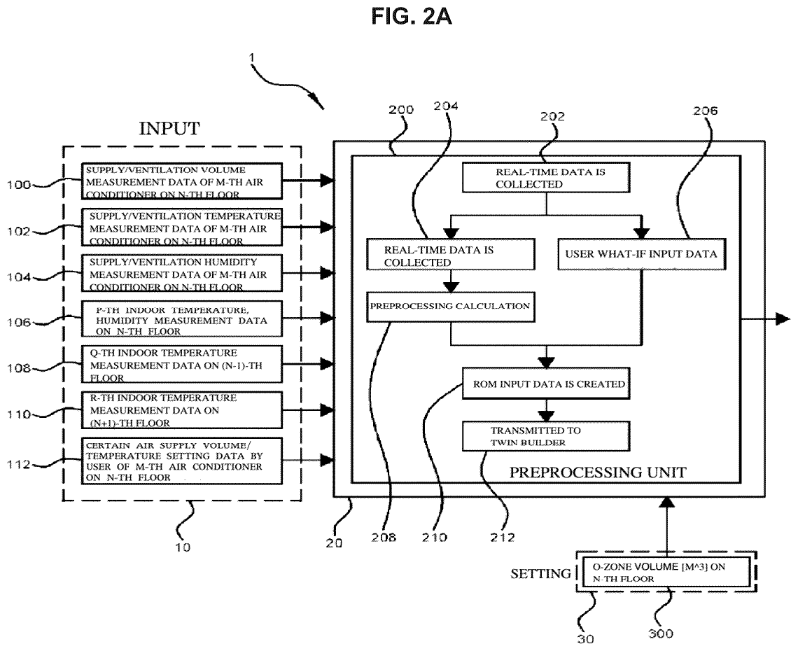

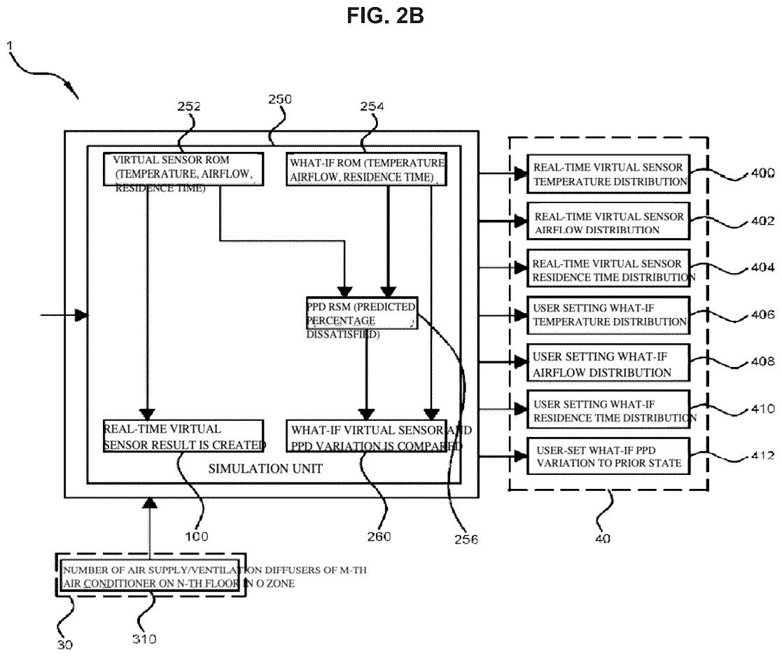

FIGS. 2A and 2B are block diagrams illustrating a real time virtual sensor monitoring system for multi use facilities according to some embodiments.

Referring to FIGS. 2A and 2B, block diagrams in which a reduced order model 1 in which the digital twin system of FIG. 1 is operated in real time are shown.

The reduced order model 1 includes an input processor 10, a calculation processor 20, a parameter creation processor 30, and an output processor 40.

The input processor 10, for example, includes a block 100 creating air supply/ventilation volume measurement data of an m-th air conditioner on an n-th floor, a block 102 creating air supply/ventilation temperature measurement data of the m-th air conditioner on the n-th floor, a block 104 creating air supply/ventilation humidity measurement data of the m-th air conditioner on the n-th floor, a block 106 creating air supply/ventilation volume measurement data of an p-th air conditioner on the n-th floor, a block 108 creating q-th indoor temperature measurement data of an (n−1)-th floor, a block 110 creating r-th indoor temperature measurement data of the (n−1)-th floor, and a block 112 creating certain air supply volume/temperature setting data by a user of the m-th air conditioner on the n-th floor.

The data created in the input processor 10 is transmitted to the calculation processor 20.

The calculation processor 20 includes a preprocessing processor 200 and a simulation processor 250.

The preprocessing processor 200 includes a block 202 collecting real-time data, a block 204 collecting real-time measurement data of real-time data, a block 206 collecting user What-IF data in real-time data, a preprocessing calculation block 208, a reduced order model input data creation block 210, and a Twin Builder transmission block 212.

The preprocessing processor 200 has a reduced order model composed of computational fluid dynamics (CFD) result data through a digital twin system, and accordingly, can calculate temperature, velocity, residence time virtual sensor result, etc. of locations and numbers designated by a user of an actual operational demonstration site on the basis of real-time measurement data.

The data calculated in the preprocessing processor 200 is transmitted to the simulation processor 250.

The simulation processor 250 includes a virtual sensor reduced order model block 252, a What-IF reduced order model block 254, a Predicted Percentage of Dissatisfied (PPD) Response Surface Methodology (RSM) block 256, a real-time virtual sensor result creation block 100, and a What-IF virtual sensor and PPD variation comparison block 260.

The calculation processor 20 calculates temperature, velocity, residence time virtual sensor result, etc. of locations and numbers designated by a user of a demonstration site through simulation when user-desired air conditioner setting data is applied in the same environmental conditions. Further, it is possible to improve efficiency of comfortable air-conditioning operation by comparing the actual operational air-conditioning operation state and the PPD when user-desired air conditioner setting data is applied.

The calculation processor 20 can receive parameters from the parameter creation processor 30. The parameter creation processor 30 includes an information creation block 300 for the o-zone volume [m\hat{ }3] on the n-the floor and an air supply/ventilation diffuser number creation block 310 for o-zone air supply/ventilation of the m-th air conditioner on the n-th floor. The parameter creation processor 30 can create data that divides the entire space including an air conditioner into o zones.

The data calculated in the calculation processor 20 is transmitted to the output processor 40.

The output processor 40 includes a real-time virtual sensor temperature distribution creation block 400, a real-time virtual sensor airflow distribution block 402, a real-time virtual sensor residence time distribution block 404, a user-set What-IF temperature distribution block 406, a user-set What-If airflow distribution block 408, a user-set What-If residence time distribution block 410, and an exiting-relative user-set What-If PDD variation block 412.

As described above, the real time virtual sensor monitoring system for multi use facilities according to some embodiment can calculate temperature, velocity, residence time virtual sensor result, etc. of locations and numbers designated by a user of an actual operational demonstration site on the basis of real-time measurement data through the reduced order model.

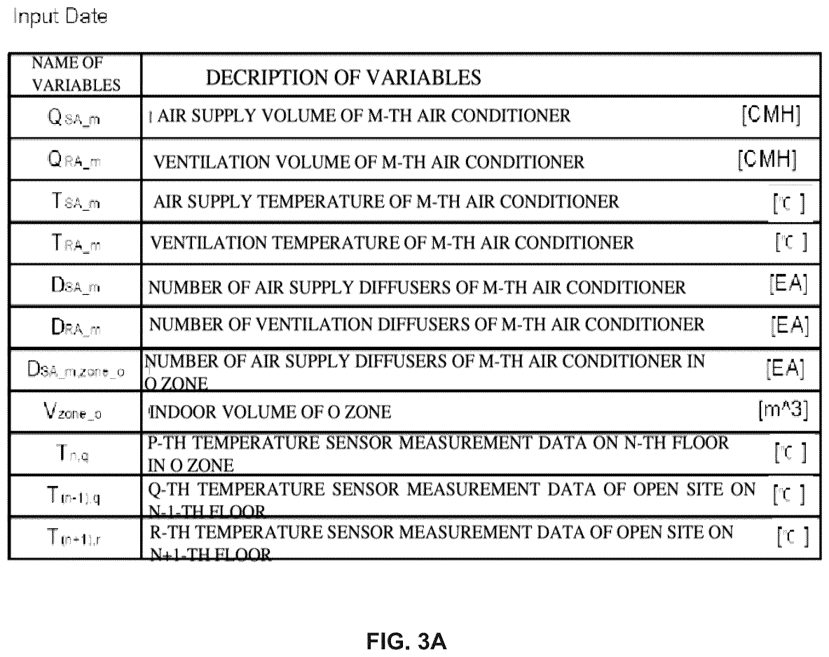

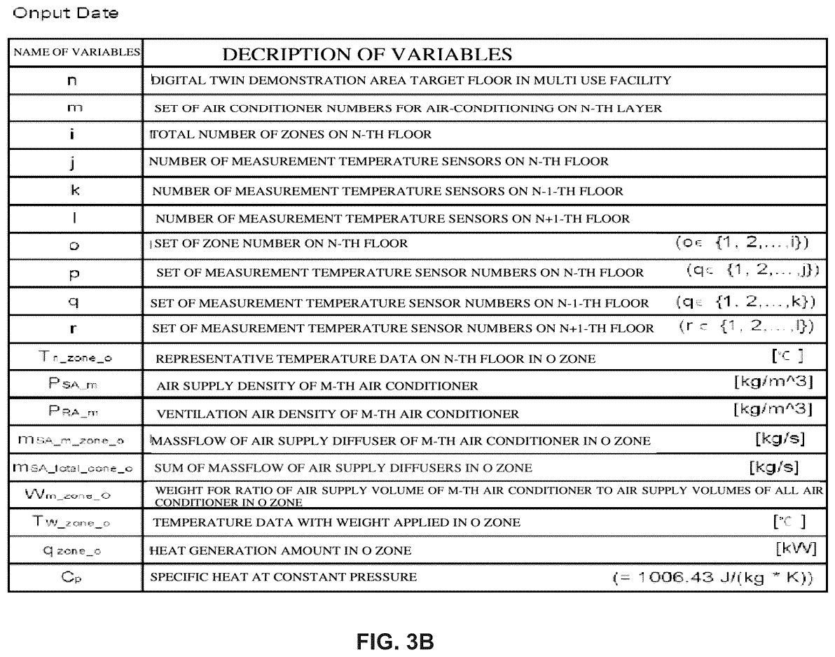

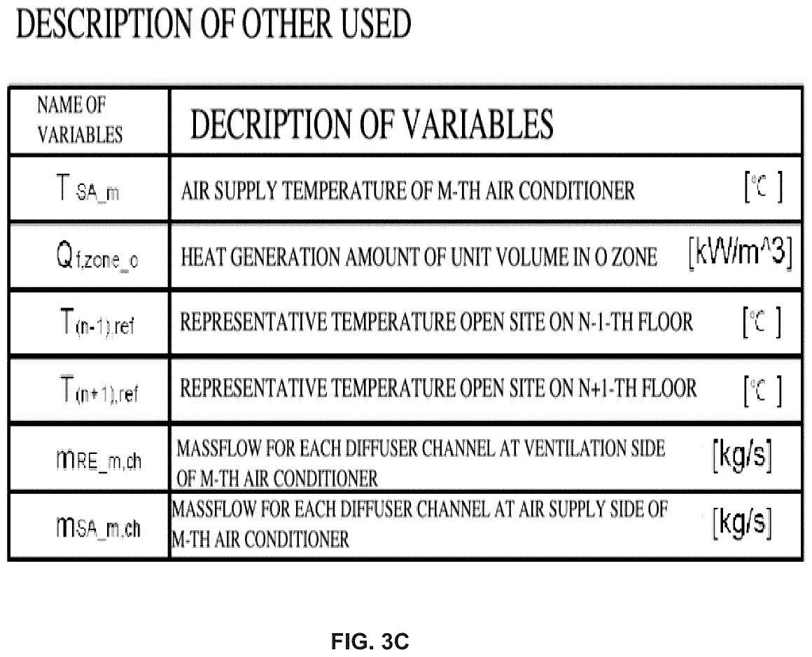

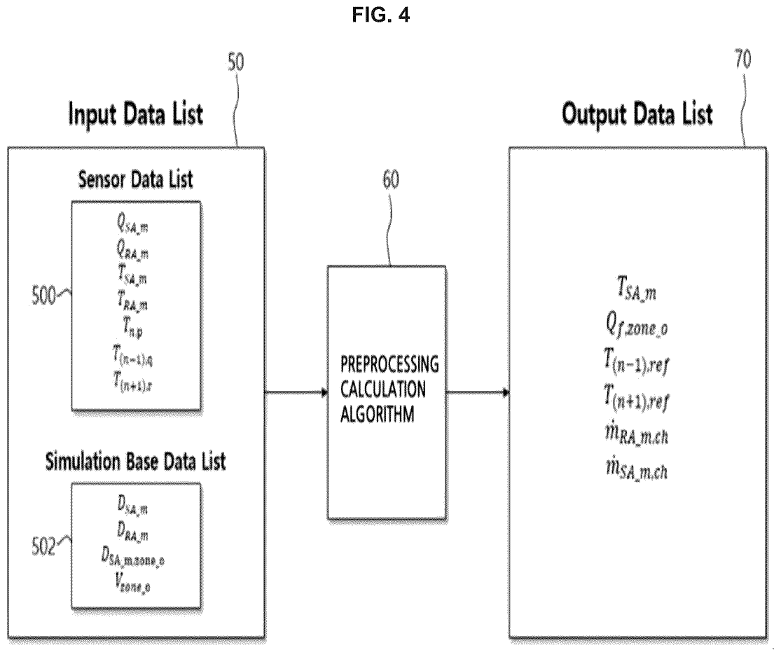

FIGS. 3A to 3C are exemplary parameter tables illustrating preprocessing calculation in the operating method of a real time virtual sensor monitoring system for multi use facilities according to some embodiments. FIG. 4 is an exemplary block diagram illustrating a preprocessing device of the real time virtual sensor monitoring system for multi use facilities according to some embodiments.

Referring to FIGS. 3A to 3C and FIG. 4, before the real-time simulation according to FIGS. 1A and 1B and FIGS. 2A and 2B is performed, it is possible to calculate and use simulation boundary conditions using environmental measurement data collected by the BAS to consider the number of air-conditioning exhaust outlets and resistance at the outlets (uniform exhaust), and the interrelated effect, heat generation due to the flow of people, etc. at open sites such as central halls to use measurement data as simulation boundary conditions.

FIGS. 3A to 3C are tables showing explanation of parameters that are used for preprocessing calculation.

The preprocessing device 2 of FIG. 4 includes an input data list block 50, a preprocessing calculation algorithm block 60, and an output data list block 70.

The input data list block 50 includes a sensor data list block 500 and a simulation base data list block 502.

The output data list block 70 stores/updates output values obtained through a preprocessing calculation algorithm into a database for data of the input data list block 50.

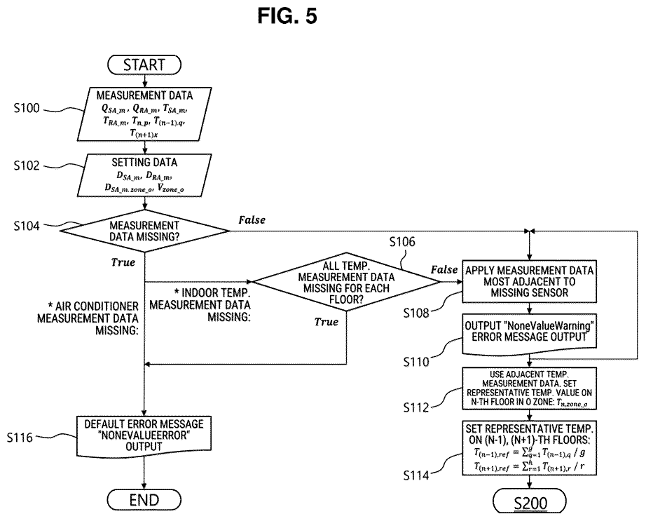

In this case, work of determining whether there is a missing sensor is performed, as in FIG. 5, before the boundary condition calculation process according to FIGS. 3A to 3C and FIG. 4.

FIG. 5 is an exemplary flowchart illustrating a preprocessing operation in the operating method of a real time virtual sensor monitoring system for multi use facilities according to some embodiments.

Referring to FIGS. 3A to 3C to FIG. 5, measurement data is received (S100). Thereafter, setting data is created on the basis of the measurement data (S102). Thereafter, whether measurement data is missing is determined (S104). If it is true, whether air conditioner measurement data is missing or indoor temperature measurement data is missing is determined. If the air conditioner measurement data is missing, a default input value and an error message ‘NoneValueError’ are output (S116). If not, and if the indoor temperature measurement data is missing, whether all the temperature data for each floor is missing is determined (S106). If so (True), a default input value and an error message ‘NoneValueError’ are output (S116). If it is not (False) in step S106, measurement data closest to the missing sensor is applied as a substitution (S108). Thereafter, an error message ‘NoneValueWarning’ is output. Thereafter, a representative temperature value of the o zone on the n-th floor is set to use adjacent temperature measurement data (S112). Thereafter, representative temperature of the (n−1)-th and (n+1)-th floors (S114).

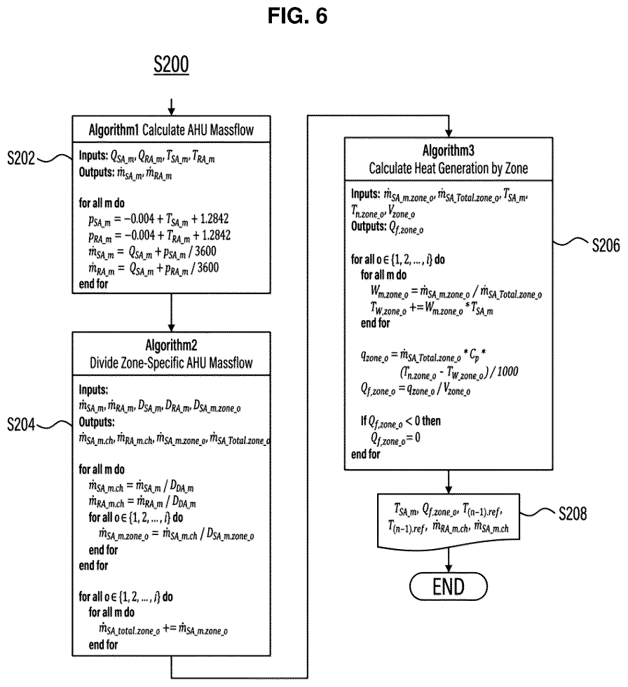

If it is not true (False) in step S104, the method returns to step S112. The method moves to step S200 after step S114. Step S200 will be described with respect to FIG. 6.

FIG. 6 is an exemplary flowchart illustrating the algorithm of the preprocessing operation in the operating method of a real time virtual sensor monitoring system for multi use facilities according to some embodiments.

Referring to FIG. 6, AHU mass flow is calculated in accordance with an Algorithm 1 (S202). Thereafter, zone-specialized AHU mass flow is divided in accordance with Algorithm 2 (S204). Thereafter, heat created for each zone is calculated in accordance with Algorithm 3 (S206). Thereafter, output data is created (S208).

Energy such as heat generated by human and heat generated by equipment should be reflected to improve accuracy of a simulation result. In particular, in the case of heat generated by human, due to the characteristics of a multi use facility space, there is large variability by season, day, and hour, so analysis considering this should be performed. Indoor loads corresponding to the heat generated by human, equipment, etc. can be applied by calculating the heat generation amount as air supply temperature, air volume, and indoor temperature data of an air conditioner measured in real time, and the calculated heat generation amount can be calculated under the assumption that all loads such as light, equipment, and human loads as air-conditioning loads. Further, it is possible to improve simulation accuracy by dividing the interior of a demonstrate site into arbitrarily set o zones and applying different heat generation amounts according to the representative measurement temperature of each zone in consideration of variability of indoor people.

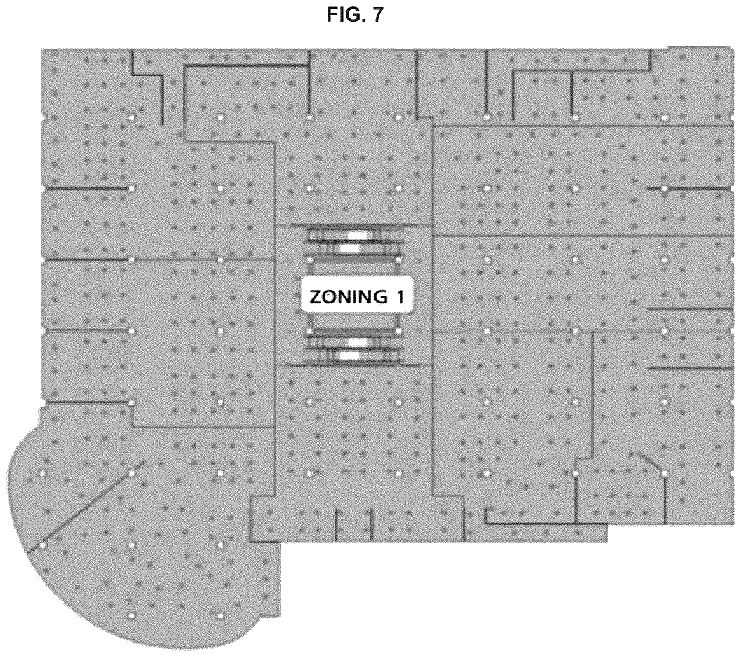

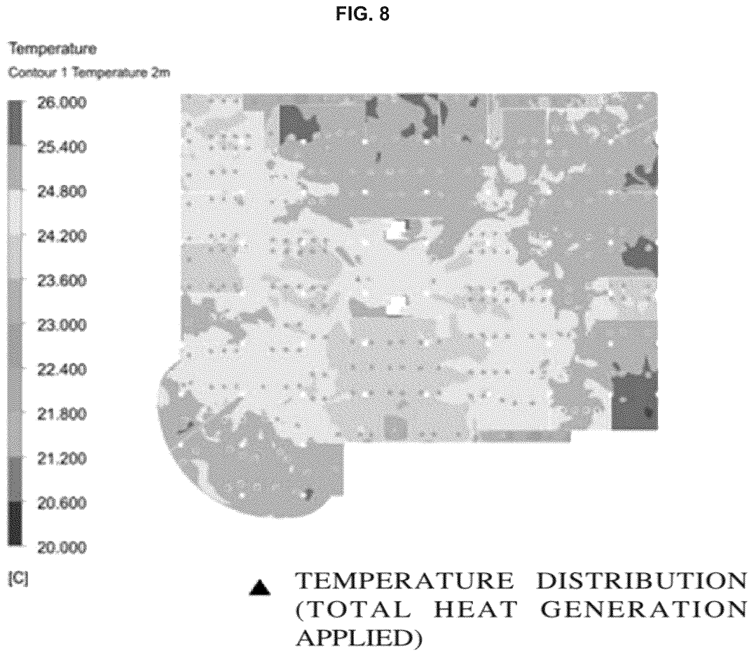

FIG. 7 is an exemplary diagram when the total heat generation amount for the entire area of a monitoring site is collectively applied to the operation of the real time virtual sensor monitoring system for multi use facilities. FIG. 8 is an exemplary diagram showing temperature distribution according to FIG. 7.

Referring to FIGS. 7 and 8, when a method of collectively applying heat generation amounts using air conditioner data and indoor average temperature for the entire area of a demonstration site is applied, the total thermal load is estimated without considering various temperature changes in the indoor space, so accuracy decreases. FIG. 8 shows the result of applying the total heat generation amount through temperature virtual sensor data at a 2 m height point through simulation.

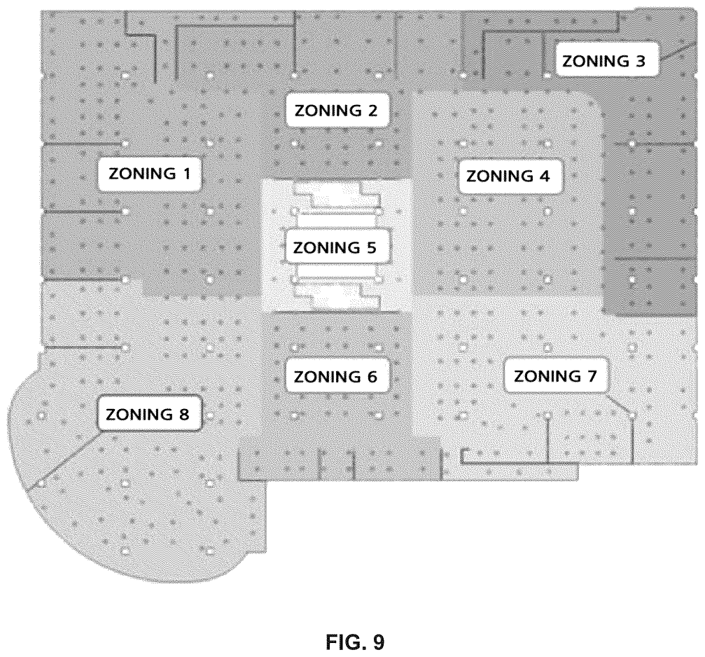

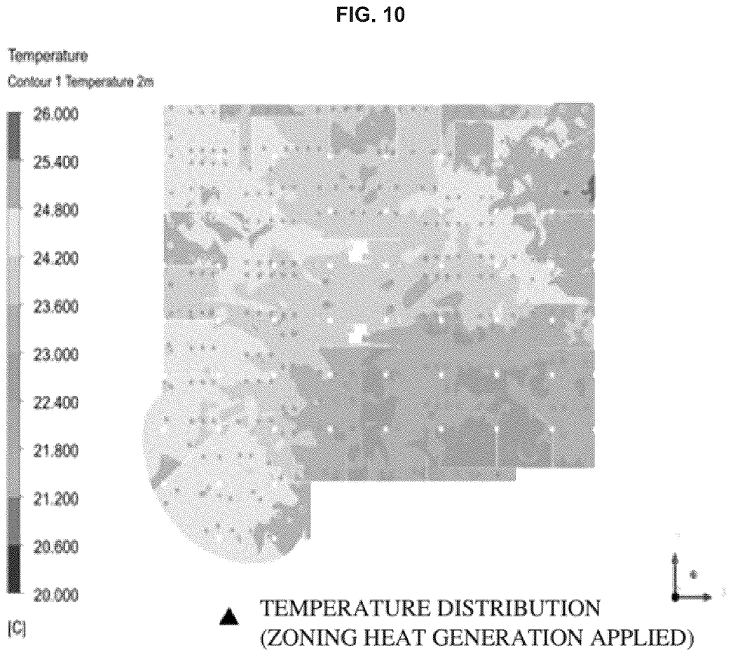

FIG. 9 is an exemplary diagram when the heat generation amounts of divided sections of the section of the entire area of a monitoring site are collectively applied to the operation of the real time virtual sensor monitoring system for multi use facilities according to some embodiments. FIG. 10 is an exemplary diagram showing temperature distribution according to FIG. 9.

Referring to FIGS. 9 and 10, in order to improve accuracy in consideration of various temperature changes in an indoor space, for example, an example of dividing an indoor environment into 8 zones and applying a heat generation amount to each zone on the basis of adjacent environmental sensor representative temperature value and air conditioner data is shown. Accordingly, in the case of FIG. 10, it is the result of applying the total heat generation amount through a temperature virtual sensor data at a 2 m height point through simulation, in which it is possible to see that the temperature is uniform and is maintained at appropriate temperature.

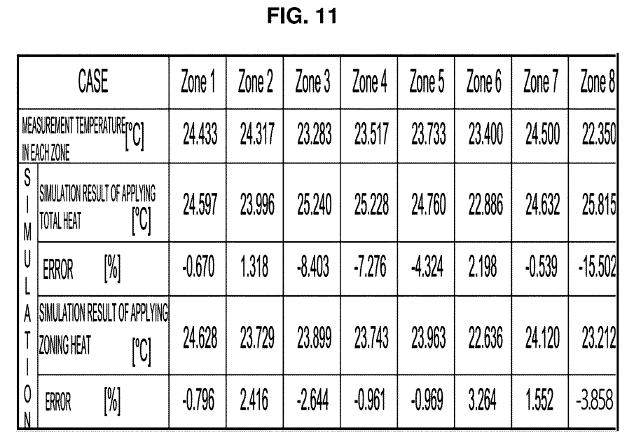

FIG. 11 is an exemplary table illustrating the accuracy of the operation of the real time virtual sensor monitoring system for multi use facilities according to some embodiments. In FIG. 11, measurement temperature and a simulation data (simulation result of apply general heat generation, errors, simulation result of apply zoning heat generation, and errors) for each zone are shown for each of zones (zones 1 to 8).

Referring to FIG. 11, it can be seen that the maximum error of the result of applying the heat generation of the entire zone according to FIGS. 7 and 8 is 15.5 percent, but the maximum error in the simulation of applying the heat generation of each zone according to FIGS. 9 and 10 according to some embodiments is about 3.8 percent and the accuracy is improved.

Although embodiments of the present disclosure were described above with reference to the accompanying drawings, those skilled in the art would understand that the present disclosure may be implemented in various ways without changing the necessary features or the spirit of the prevent disclosure. Therefore, the embodiments described above are only examples and should not be construed as being limitative in all respects. The patent right of the present disclosure should be construed by the following claims and the scope and spirit of the disclosure should be construed as being included in the patent right of the present disclosure.

1. A real time virtual sensor monitoring system for multi use facilities, comprising:
an input processor configured to create a plurality of air conditioner measurement data and a plurality of indoor environmental measurement data in a multi use facility;
a calculation processor including a preprocessing processor configured to receive and preprocess the plurality of air conditioner measurement data and the plurality of indoor environmental measurement data, and a simulation processor configured to receive preprocessed data through the preprocessing processor and perform simulation;
a parameter creation processor configured to transmit information dividing the multi use facility into o (o is a natural number) zone to the calculation processor; and
an output processor configured to receive the result of the simulation through the calculation processor and output virtual sensor distribution,
wherein the preprocessing processor includes:
a block configured to collect real-time data through sensors in the multi use facility,
a block configured to transmit measurement data sensed at every cycle in the real-time data to a building automation system,
a block configured to transmit input data for user-desired simulation air handing processor (AHU) setting values in the real-time data to the building automation system,
a block configured to perform preprocessing calculation on data of the block transmitting the measurement data sensed at every cycle,
a block configured to receive the data preprocessed by the block performing preprocessing calculation and the user-desired simulation AHU setting values and create reduced order model input data, and
a block configured to transmit the reduced order model input data to a Twin Builder, and
wherein the simulation processor includes:
a virtual sensor reduced order model block,
a user-desired simulation AHS setting value reduced order model block,
a block creating a real-time virtual sensor result through the virtual sensor reduced order model block, and
a block comparing a What-If virtual sensor variation through a value of the user-desired simulation AHS setting value reduced order model block.

2. The real time virtual sensor monitoring system of claim 1, wherein the simulation processor further includes a block configured to create PPD RSM by receiving data of the virtual sensor reduced order model block and by receiving a value of the user-desired simulation AHS setting value reduced order model block.

3. The real time virtual sensor monitoring system of claim 1, wherein the plurality of air conditioner measurement data comprise air supply or ventilation volume, temperature, and/or humidity.

4. The real time virtual sensor monitoring system of claim 1, wherein the multi use facility comprises n floors (n is a natural number) and the n floors each include an open site,
wherein the plurality of air conditioner measurement data comprise data measured through an air conditioner included in the n-th floor of the multi use facility,
wherein the plurality of indoor environmental measurement data comprise data measured through a p-th sensor (p is a natural number) included in the n-th floor of the multi use facility, and
wherein the input processor configured to create all of indoor environmental measurement data included in the open site of an n−1-th floor of the multi use facility and indoor environmental measurement data included in the open site of an n+1-th floor.

5. The real time virtual sensor monitoring system of claim 4, wherein in response to the sensor creating indoor environmental measurement data of the n-th floor is poor, a sensor creating a p−1-th or p+1-th indoor environmental measurement data is configured to be used.

6. An operating method of a real time virtual sensor monitoring system for multi use facilities, the operating method comprising:
transmitting sensor measurement data to a building automation system (BAS) at every cycle through a processing device disposed in a multi use facility;
transmitting user-desired simulation air handing processor (AHU) data to the BAS through the processing device disposed in the multi use facility;
collecting real-time data, and storing and updating a real-time data DB by means of the BAS;
receiving the stored and updated data through communication Python Code;
discriminating real-time sensor measurement data in the received data and the user-desired simulation AHU data, calculating preprocessing calculation on the real-time sensor measurement data, and transmitting the data on which preprocessing calculation has been performed and the user-desired simulation AHU data as input data of a Twin Builder by means of the Python Code; and
performing a reduced order model through a digital twin system using a reduced order model by means of the Twin Builder.

7. The operating method of claim 6, wherein the Twin Builder comprises an ANSYS Twin Builder.

8. The operating method of claim 6, wherein the Twin Builder is configured to construct the reduced order mode composed of Computational Fluid Dynamics (CFD) result data.

9. The operating method of claim 6, wherein data from the communication Python Code to the Twin Builder is configured to be converted into binary data and transmitted through TCP/IP communication.

10. The operating method of claim 6, further comprising:
performing a reduced order model through the digital twin system using a reduced order model and creating a virtual sensor What-If value created through the user-desired simulation AHU data by means of the Twin Builder.
